(19) United States
(12) Patent Application Publication
(10) Pub. No.: US 2010/0322544 A1
(43) Pub. Date: Dec. 23, 2010

(54) Bearing assembly having a dust seal arrangement with contacting and non-contacting dust seals

(75) Inventors: Paul A. Hubbard, Petersburg, VA (US); John Oliver, Flossmoor, IL (US)

Correspondence Address: AMSTED Industries Incorporated;Two Prudential Plaza, Suite 1800, 180 N. Stetson, Chicago, IL, 60601, US

(73) Assignee: AMSTED Rail Company, Inc.

(21) Appl. No.: 12/456,685

(22) Filed: Jun. 22, 2009

(51) Int. Cl. F16C 33/76

(52) U.S. Cl. 384/478; 384/486

(57) ABSTRACT

A bearing assembly is presented having a novel lubricant sealing design that, in one embodiment, combines the advantages of contacting and non-contacting dust seals to balance energy efficiency while still providing an effective method for contaminant exclusion. The contacting and non-contacting dust seals further arranged to maximize the service life of the dust seals and prolong the maintenance intervals required on the bearing assembly.

### FIELD OF THE INVENTION

This invention relates to anti-friction bearings and more particularly, in one embodiment, to tapered roller bearings.

### BACKGROUND OF THE INVENTION

Anti-friction bearings (also commonly known as rolling-contact bearings), such as ball bearings and tapered roller bearings, are commonly used in various industrial applications. Anti-friction bearings are typically purchased preassembled, ready for press fit onto a shaft.

A lubricant (e.g., oil or grease) is applied to the bearing's rollers to minimize friction and wear. The quantity and quality of the lubricant have a significant effect on bearing life. A bearing operating with inadequate lubrication may quickly overheat and fail.

To maximize the life of the bearing, seals are used to retain lubricant within the bearing and exclude environmental contaminants. A good seal design strives to protect the bearing lubricant while balancing the need to minimize friction losses resulting from the bearing seal.

Bearings used in the railway industry to support railcar axles are a particularly demanding application, requiring energy efficiency while providing protection against environmental contaminants (such as water, dirt, sand etc.). Even within the railway industry, certain types of railcars (and their bearings) are exposed to particularly severe environmental operating conditions.

For example, the bearings of hopper cars must withstand contaminants introduced by the cargo itself. Coal dust, gypsum, cement, and any variety of industrial chemicals and minerals may be hauled in bulk and potentially contaminate the bearing. Particulate contaminants entering the bearing can potentially cause abrasive damage and bearing failure.

The abrasive action of even small amounts of contaminants can increase bearing friction, causing overheating of the lubricant or directly damaging bearing components. Consequently, it is critically important that a bearing effectively exclude environmental contaminants from the bearing while simultaneously sealing the lubricant within the bearing while providing reliable, low maintenance, and energy efficient service.

### SUMMARY OF THE INVENTION

A bearing assembly is presented having a novel bearing seal for excluding environmental contaminants and retaining bearing lubricant. In one embodiment, the seal body has two portions: a lubricant seal portion and a dust seal portion. The dust seal portion of the seal body has a novel design that incorporates features to preclude contaminants from entering and migrating to the interior of the bearing assembly. One feature is the use of a primary dust seal and a secondary seal (known together as a double dust seal) in conjunction with an auxiliary dust seal.

The dust seals are designed in various embodiments as either contacting seals or non-contacting seals to achieve a balance between contaminant exclusion, energy efficiency, and service life. The primary dust seal is a contacting seal providing the first defense against contaminant intrusion. The secondary seal is a non-contacting seal selected for energy efficiency and yet still provides effective contaminant exclusion. The auxiliary seal, depending upon the embodiment, may be either contacting or non-contacting. The non-contacting embodiment is an energy-efficient design for trapping particulate contaminants escaping the primary and secondary seals. In the alternative embodiment, the auxiliary seal is a contacting seal. Although less energy-efficient, the contacting auxiliary seal embodiment provides a tighter seal against contaminant intrusion.

In addition to the sealing capability of the dust seals, contaminant intrusion into the bearing is further inhibited by the annular chambers created by the dust seals. The annular chambers form a particulate trap for contaminants such as dirt, dust, sand.

### BRIEF DESCRIPTION OF THE FIGURES

Various embodiments of the bearing assembly and seal body are described and illustrated in the accompanying figures. The figures are provided as examples only and are not intended to be considered as limitations to the invention. Consequently, the bearing assembly and seal body are illustrated by way of example and not by limitation in the accompanying figures in which:

FIG. 1 is a sectional view of one embodiment of the bearing assembly;

FIG. 2 is a detailed sectional view of one embodiment of the seal case depicted in the bearing assembly embodiment illustrated in FIG. 1;

FIG. 3 is a perspective view of the seal body embodiment illustrated in FIG. 2; and

FIG. 4 is a detailed sectional view of the seal body embodiment illustrated in FIG. 3.

### DETAILED DESCRIPTION

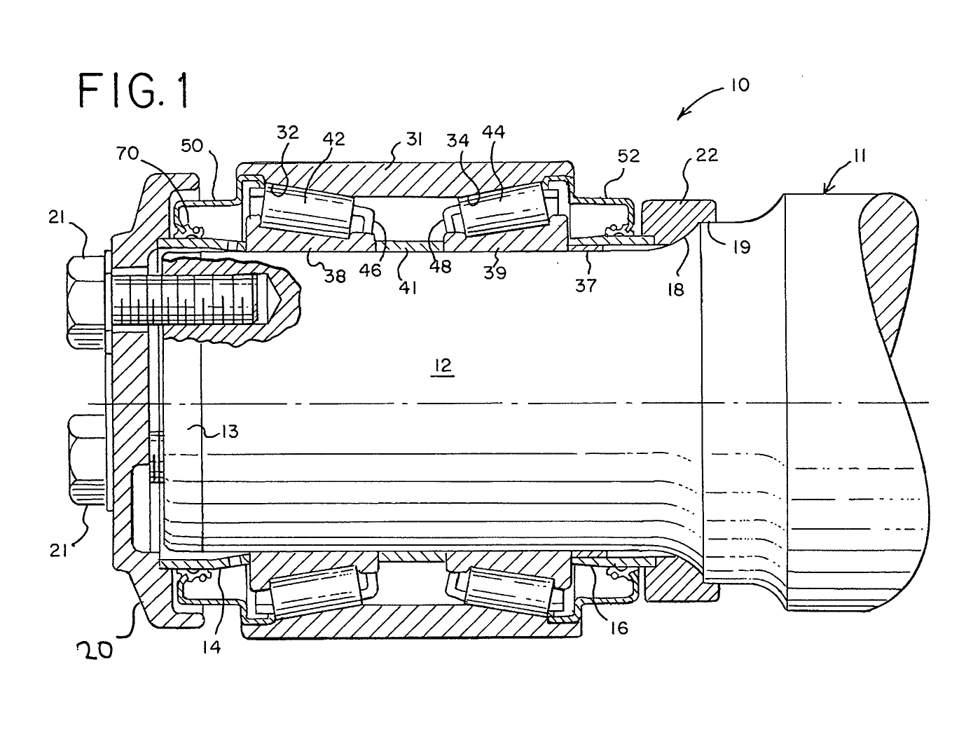

Referring to FIG. 1, an exemplary bearing assembly 10 is illustrated. In this embodiment, the bearing assembly 10 is a tapered roller bearing of the type commonly used in railway applications to support a low friction railcar wheel. The bearing assembly 10 described in the following embodiments, however, may be adapted for use in many other common industrial applications. Consequently, the bearing assembly 10 illustrated and described below in relation to a tapered roller bearing assembly for a railcar wheel is for convenience only. Furthermore, although the embodiments described and illustrated in the figures refer to tapered roller bearing assemblies, the novel bearing assembly and sealing system described and claimed is generally applicable to anti-friction bearings.

The bearing assembly 10 is typically preassembled before being mounted on a shaft 11 (e.g., a railcar axle). At the free end of the shaft 11, a journal 12 terminates in a slightly conical, tapered guide 13 to facilitate installation of the bearing assembly 10 onto the journal. The bearing assembly 10, in one embodiment, is press fit on the journal 12 of the shaft 11. The journal 12 is machined to very close tolerances to accurately accommodate the press fit.

Wear rings 14, 16 fit over the journal 12 and abut the bearing assembly 10. The wear rings 14, 16 typically have an inner diameter dimension to provide an interference fit with the journal 12 over least a portion of its length so that the entire assembly, in one embodiment, is pressed as a unit onto the end of the journal 12. The wear rings 14, 16 become, in effect, an integral part of the shaft 11, rotating with the shaft as it turns.

The journal 12 terminates at its inner end in a contoured fillet 18 leading to a cylindrical shoulder 19 on the shaft 11. A backing ring 22 is affixed by the shoulder 19. A wear ring 16 is captured between the backing ring 22 and the bearing assembly 10.

A bearing retaining cap 20 having a plurality of bores is mounted at the free end of the shaft 11 with threaded cap screws or bolts 21. The bearing retaining cap 20 captures the wear ring 14 against the bearing assembly 10. The bearing retaining 20 and the backing ring 22 effectively clamping the bearing assembly 10, including the wear rings 14, 16, into position on the journal 12 of the shaft 11.

As indicated above, the bearing assembly 10 is preassembled from a number of individual components. The bearing assembly 10 includes a bearing cup 31 having raceways 32, 34 formed on the inner surface of the bearing cup. The raceways 32, 34 cooperate with bearing cones 38, 39 to capture and support two rows of tapered rollers 42, 44 respectively. In some embodiments, cages 46, 48 maintain the spatial position of the rollers 42, 44 within the raceways 32, 34. A center spacer 41 is positioned between the bearing cones 38, 39 to maintain the cones in accurately spaced position relative to one another and allow for proper bearing lateral clearance.

Seal cases 50, 52 cover the ends of the bearing assembly 10, helping to protect the bearing from external contaminants and substantially sealing the lubricant within the bearing assembly. In one embodiment, the seal cases 50, 52 are affixed to the stationary (i.e., non-rotating) side of the bearing assembly 10 (such as the bearing cup 31) by interference fit or other appropriate method. The seal case design and sealing function are described in greater detail below.

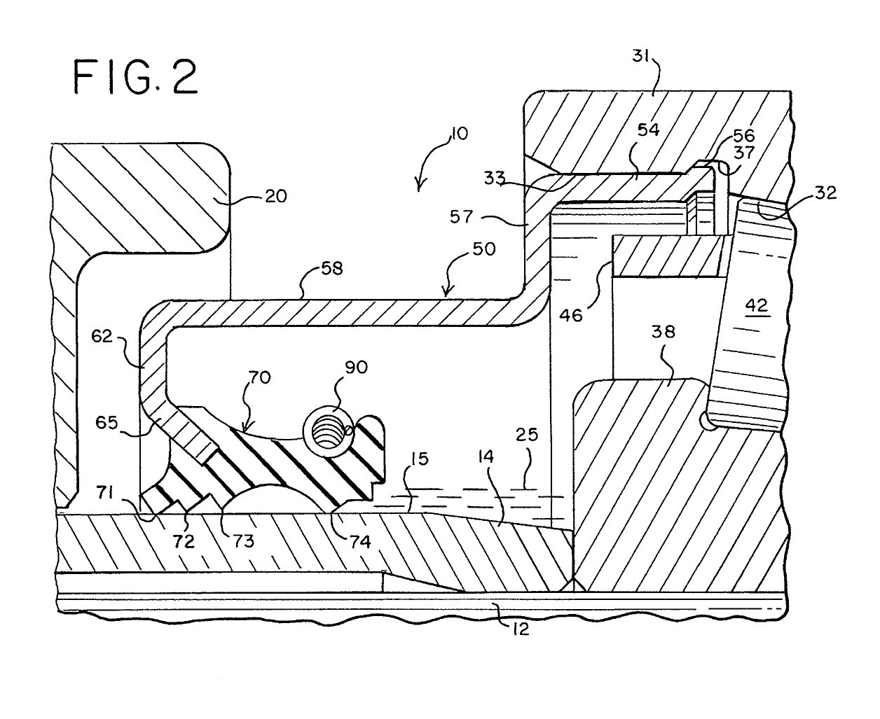

Referring to FIG. 2, the seal case 50 of the bearing assembly 10 of FIG. 1 is illustrated in a detailed sectional view (with only one end portion depicted). The seal case 50 in one embodiment, as discussed above, may be affixed to the bearing cup 31 with an interference fit. For example, the seal case 50 has a large diameter open end section 54 which may be press fit into the counterbore 33 in the bearing cup 31. Alternatively, in another embodiment, the seal case 50 may have a retaining lip 56 adapted to snap into an undercut retaining groove 37 in the bearing cup 31. This design allows the seal case 50 to be releaseably retained on the bearing assembly 10.

The seal case 50 has a generally cylindrical form. A seal case intermediate section 58 has a smaller diameter cylindrical section running parallel to the open end section 54. A seal case outer radial section 57 extends between the seal case intermediate section 58 and the open end section 54. An inner radial section 62 extends radially inward from the intermediate section 58. The seal case 50 terminates in a mounting ring 65 extending from the inner radial section 62.

A seal body 70 is attached to the mounting ring 65 and extends to contact a wear surface 15. The wear surface 15 may be provided by either the journal 12 or a wear ring 14 fitted over the journal 12. For example, in one embodiment, a wear surface is established between the stationary seal body 70 and the rotating wear ring 14, allowing the rotating and non-rotating bearing assembly 10 components to move relative to each other. The seal case 50 (and the seal body 70) operating in conjunction with the wear ring 14 (or shaft in some embodiments) is designed to control lubricant leakage and protect both the bearing assembly 10 and lubricant 25 from contaminants.

In one embodiment, the seal body 70 is molded on and permanently bonded to mounting ring 65. In this embodiment, the seal body 70 is an integrally molded annular ring of elastomeric or rubber-like material of suitable density and hardness selected for the particular application as is known in the art. For example, common materials of construction for the seal body 70 include Nitrile Butadiene Rubber (NBR), Viton™, silicone, etc. The seal body 70, however, may be constructed of other materials (e.g., felt, thermoplastic and thermosetting polymers) or combinations of materials (e.g., a fabric reinforced elastomeric material).

Seals constructed from elastomeric materials are useful for providing a resilient seal. The resiliency of the seal urges the seal body 70 against the wear surface 15, exerting a substantially constant pressure to resist lubricant leakage and contaminant intrusion.

To further increase the sealing force exerted by the seal body 70 on the wear surface 15, a mechanical spring 90 (such as an endless coil or garter spring) may back the seal body 70. These springs are designed to maintain a continuous, controlled sealing pressure between the seal body 70 and wear surface 15. In one embodiment, a spring retaining groove 91, located circumferentially around the exterior surface of the seal body 70, captures the spring 90. The spring 90 is optional, and may be omitted to enable a lighter contact or non-contacting seal to be formed. An example of such a spring backed seal is described in U.S. Pat. No. 5,186,548, entitled “Bearing Shaft Seal,” granted Feb. 16, 1993, to Sink which is hereby incorporated by reference in its entirety.

The seal body 70, in one embodiment, is urged against the wear ring 14 to seal the bearing assembly 10. The wear ring 14 protects the journal 12 against rubbing wear from the seal body 70. Direct contact between the seal body 70 and the journal 12 could potentially create sufficient rubbing wear to degrade and potentially cause shaft failure. This wear is accelerated by the presence of abrasive particulate contaminants such as sand in the lubricant.

The wear ring 14 is designed and manufactured to produce a surface hardness capable of resisting rubbing wear damage from the seal body 70. In the event that the wear ring 14 does become damaged it can be replaced relatively easily, particularly in comparison to the cost of replacing a shaft.

It is possible, in one embodiment, to eliminate the wear ring 14 and urge the seal body 70 directly against the shaft. For reasons noted above, this is generally not the best practice. Consequently, for these reasons and for ease of description, the subsequent descriptions of the bearing assembly 10 will assume the use of a wear ring 14 in conjunction with the bearing assembly.

The bearing assembly 10 is typically pre-lubricated prior to shipment by the manufacturer. The lubricant 25 most commonly used in the bearing assembly 10 is grease. During assembly, grease is typically applied to both the rollers 42 and to the seal body 70. This pre-packed grease helps ensure that the bearing assembly 10, when first installed, receives sufficient lubrication to minimize startup wear on the new assembly.

In this embodiment, the seal body 70 has a lubricant seal 74 at one end and dust seals 71, 72, and 73 at the other end. The lubricant seal 74, in one embodiment, is directed axially inward (i.e., toward the bearing cup 31) and is resiliently urged against the wear surface 15 of wear ring 14 to impede lubricant loss from the bearing assembly.

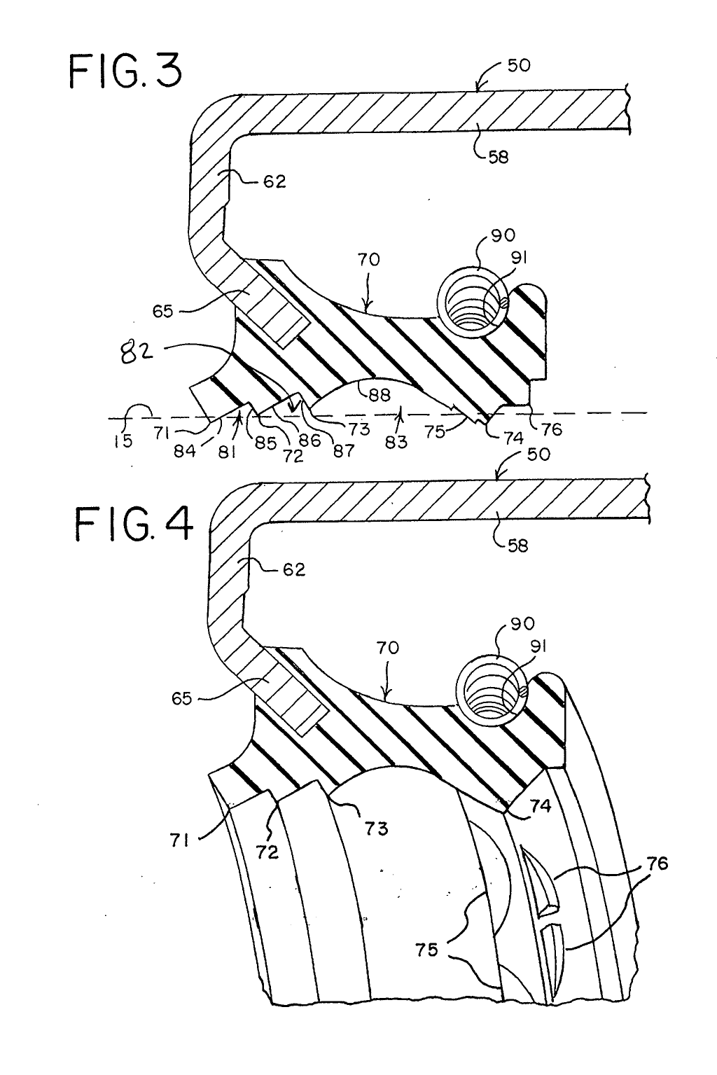

Referring now to FIG. 3, a detailed perspective view of one embodiment of the seal body 70 of FIG. 2 is illustrated. Various designs may be incorporated into the lubricant seal 74 to enhance the seal's ability to minimize lubricant loss. This includes the use of hydrodynamic surfaces 75 located axially outward (i.e., away from the bearing cup) from the lubricant seal 74 and lubricant deflectors 76 located axially inward (i.e., toward the bearing cup) of the lubricant seal 74. These lubricant seal designs are discussed in detail in U.S. Pat. No. 5,511,886, entitled “Bearing Seal with Oil Deflectors,” granted Apr. 30, 1996, to Sink which is hereby incorporated by reference in its entirety.

The lubricant deflectors 76 are designed to minimize lubricant in the area axially inward and adjacent to the lubricant seal 74. Lubricant deflectors 76 are aligned circumferentially around the seal body 70 and extend radially inward. Like stationary impellers, the lubricant deflectors 76 force lubricant near the lubricant seal 74 back into the bearing cavity. Lubricant entrained by the rotating wear ring, impinges on the projecting deflectors 76 and is redirected toward the bearing cavity away from the lubricant seal 74, reducing lubricant leakage under the lubricant seal.

Similar to the lubricant deflectors 76, the hydrodynamic surfaces 75 are stationary and deflect lubricant entrained by the rotating wear ring axially inward toward the lubricant seal 74. The hydrodynamic surfaces 75 are aligned circumferentially around the seal body 70, axially outward of the lubricant seal 74. Projecting radially inward, the hydrodynamic surfaces 75 present a curved surface facing axially inward. Lubricant entrained by the viscous shear forces imparted by the rotating wear ring impinges these hydrodynamic surfaces 75. The hydrodynamic surfaces 75 redirect the lubricant axially inward toward the lubricant seal 74 and into the bearing cavity.

In some embodiments, neither the hydrodynamic surfaces 75 nor the lubricant deflectors 76 are necessary. In still other embodiments, only the hydrodynamic surfaces 75 or only the lubricant deflectors 76 are used in conjunction with the lubricant seal 74.

Referring to FIG. 4, the seal body 70 embodiment illustrated in FIG. 3 is shown in detailed cross-section to illustrate the contact points between the seal body 70 and the wear surface 15. As noted above, the seal body 70 has a plurality of dust seals at one end of the seal body. The first line of defense against external contaminants is the primary dust seal 71. The primary dust seal 71 is outwardly directed at the axially outward, distal end of the seal body 70. The primary dust seal 71 is a contacting seal, extending and rubbing against the wear surface 15.

Immediately adjacent and axially inward of the primary dust seal 71 is the outwardly directed, secondary dust seal 72. The secondary dust seal 72 is closely spaced (i.e., does not contact the wear surface 15). The primary dust seal 71 and the secondary dust seal 72 (also known as a double dust seal) operate in conjunction to exclude contaminants from the bearing assembly.

The primary and secondary dust seals are dimensioned such that the primary dust seal 71 is relatively flexible while the secondary dust seal 72 provides greater rigidity and consequently, stability to maintain close tolerance spacing with the wear surface 15. In practice, the difference between the diameter of the secondary dust seal 72 and the diameter of the wear surface 15 is maintained as low as practical to produce an effective seal without resulting in actual rubbing contact. In most applications, this difference should be within the range of about 0.001 to 0.008 inches.

Axially inward of the secondary dust seal 72 is the auxiliary seal 73. In one embodiment, the auxiliary seal 73 is a non-contacting seal, closely spaced but not contacting the wear surface 15. In another embodiment, however, the auxiliary seal 73, may contact the wear surface 15. The auxiliary seal 73 is available to impede particulate contaminants escaping the secondary seal 72.

In both of the above embodiments, the auxiliary seal 73 operates as a barrier to contaminant migration further into the bearing assembly. In the embodiment of the non-contacting auxiliary seal 73, significantly less degradation is expected from particle abrasion and running wear to the seal because of its non-contacting design. The non-contacting auxiliary dust seal 73 has approximately the same dimensional tolerances as the secondary dust seal 72. As a result, the non-contacting seal embodiment is expected to have a longer service life than the contacting auxiliary seal embodiment while still providing a defense against contaminate intrusion.

The contacting auxiliary seal embodiment, however, provides a tighter seal against contaminate intrusion. Although it is a contacting seal, it will still experience less wear by virtue of the effectiveness of the secondary seal 72 in reducing contaminate migration, thereby protecting the contacting auxiliary seal from excessive contaminant abrasion. The non-contacting secondary seal 72 prolongs the service life of the contacting auxiliary seal. In light of the non-contacting design of the secondary seal 72, the secondary seal 72 should experience relatively little wear, and provide protection to the contacting auxiliary seal 73 for its service life.

The effectiveness of the dust seal arrangement is further augmented by the first and second annular chambers 81, 82 formed by the dust seals around the wear ring 14. In addition to the barrier created by the dust seals, the lubricant in the annular chambers 81, 82 pins contaminants and impedes contaminant migration.

The first annular chamber 81 is created between the primary dust seal 71 and the secondary dust seal 72. Primary dust seal 71 has a circumferential surface 84 intersecting with the circumferential surface 85 of secondary dust seal 72 creating a first annular chamber 81 against the wear surface 15. Similarly, a second annular chamber 82 is formed between the circumferential surface 86 of the secondary dust seal 72 and the circumferential surface 87 of the auxiliary dust seal 73 against the wear surface 15. Finally, a third annular chamber 83 having a concave inner surface 88 is formed between the auxiliary seal 73, the lubricant seal 74, and the wear surface 15.

Each of the annular chambers provides a defense against contaminant intrusion into the bearing cavity. The annular chambers are typically pre-packed with a suitable lubricant (e.g., a grease). Contaminants entering the bearing assembly are blocked by the physical presence of the lubricant. In addition, the grease acts as a pinning agent to entrap and impede the further migration of contaminants.

The rotating wear surface 15 (e.g., the wear ring) enhances the ability of the annular chambers to capture contaminates. Particulate contaminants must travel along the rotating wear ring in order to pass under the dust seals into the bearing assembly and bearing cavity. As a result, contaminants are initially closely spaced or on the wear surface 15. The wear ring, because of its rotation, entrains lubricant and acts like a flinger, forcing particulate contaminates radially outward into the annular chamber. The grease pins the particulates in the chamber, preventing further migration of the particulates into the bearing assembly.

While the invention has been illustrated with respect to several specific embodiments, these embodiments are illustrative rather than limiting. Various modifications and additions could be made to each of these embodiments as will be apparent to those skilled in the art. Accordingly, the invention should not be limited by the above description or of the specific embodiments provided as examples. Rather, the invention should be defined only by the following claims.

The invention claimed is:

1. A bearing assembly affixed to a shaft, comprising:
a bearing cup having a raceway;
a bearing cone affixed to the shaft;
a plurality of rollers captured between the raceway and the bearing cone;
a wear surface rotating with the shaft;
a seal case affixed to the bearing cup; and
a seal body affixed to the seal case, the seal body further comprising:
a primary dust seal extending from the seal body to contact the wear surface;
a secondary dust seal disposed axially inward from the primary dust seal, the secondary dust seal extending from the seal body and closely spaced to the wear surface;
an auxiliary dust seal disposed axially inward of the secondary dust seal, the auxiliary dust seal extending toward the wear surface; and
a lubricant seal extending from the seal body to contact the wear surface, the lubricant seal disposed axially inward of the auxiliary seal.

2. The bearing assembly of claim 1, wherein the auxiliary dust seal extends to contact the wear surface.

3. The bearing assembly of claim 1, wherein the auxiliary dust seal is closely spaced to the wear surface.

4. The bearing assembly of claim 1, wherein the seal body further comprises a plurality of lubricant deflectors disposed axially inward of the lubricant seal.

5. The bearing assembly of claim 1, wherein the seal body further comprises a plurality of hydrodynamic surfaces disposed axially outward of the lubricant seal.

6. The bearing assembly of claim 1, further comprising a wear ring affixed to the shaft, wherein the wear ring provides the wear surface.

7. The bearing assembly of claim 1, further comprising a backing ring to secure the wear ring to the bearing assembly.

8. The bearing assembly of claim 1, further comprising a bearing retaining cap to secure the wear ring to the bearing assembly.

9. The bearing assembly of claim 1, wherein the shaft provides the wear surface.

10. The bearing assembly of claim 1, further comprising a spring circumferentially mounted around the seal body.

11. The bearing assembly of claim 1, further comprising a cage for separating the plurality of rollers.

12. A method for sealing a bearing assembly affixed to a shaft, comprising:
urging a seal body against a wear surface, the seal body attached to a seal case, the seal case affixed to a bearing cup, the seal body comprising:
a primary dust seal extending from the seal body to contact the wear surface;
a secondary dust seal disposed axially inward from the primary dust seal, the secondary dust seal extending from the seal body and closely spaced to the wear surface;
an auxiliary dust seal disposed axially inward of the secondary dust seal, the auxiliary dust seal extending toward the wear surface;
a lubricant seal extending from the seal body to contact the wear surface, the lubricant seal disposed axially inward of the auxiliary seal; and
a plurality of lubricant deflectors disposed axially inward of the lubricant seal; and
rotating the shaft to induce flow of lubricant inside the bearing assembly;
whereby the plurality of lubricant deflectors redirect the flow of the lubricant axially inward, and further whereby the seal body forms a seal with the wear surface.

13. The method of claim 12, wherein the auxiliary dust seal contacts the wear surface.

14. The method of claim 12, wherein the auxiliary dust seal is closely spaced to the wear surface.

15. The method of claim 12, wherein a wear ring provides the wear surface.

16. The method of claim 12, wherein the primary dust seal and the secondary dust seal form a first annular chamber and the secondary dust seal and the auxiliary dust seal form a second annular chamber.

17. The method of claim 16, wherein the flow of lubricant urges contaminants radially outward into the first annular chamber and the second annular chamber.

18. A bearing assembly affixed to a shaft, comprising:
a bearing cup having a raceway;
a bearing cone affixed to the shaft;
a plurality of rollers captured between the raceway and the bearing cone;
a cage to separate the rollers;
a wear ring having a wear surface;
a seal case affixed to the bearing cup; and
a seal body affixed to the seal case, the seal body further comprising:
a primary dust seal extending from the seal body to contact the wear surface;
a secondary dust seal disposed axially inward from the primary dust seal, the secondary dust seal extending from the seal body and closely spaced to the wear surface;
an auxiliary dust seal disposed axially inward of the secondary dust seal, the auxiliary dust seal extending to contact the wear surface;
a lubricant seal extending from the seal body to contact the wear surface, the lubricant seal disposed axially inward of the auxiliary seal; and
a plurality of lubricant deflectors extending circumferentially around the seal body and disposed axially inward of the lubricant seal.

19. The bearing assembly of claim 18, further comprising a plurality of hydrodynamic surfaces extending circumferentially around the seal body and disposed axially outward of the lubricant seal.

20. The bearing assembly of claim 18, further comprising a spring extending circumferentially around the seal body to urge the seal body against the wear ring.
